(19) United States
(12) Patent Application Publication
(10) Pub. No.: US 2010/0300369 A1
(43) Pub. Date: Dec. 2, 2010

(54) Covering structure for exterior of aquarium

(75) Inventors: Chien-Sheng Fang, Keelung City (TW); Chu-Han Hsin, Keelung City (TW)

Correspondence Address: Muncy, Geissler, Olds & Lowe, PLLC, 4000 Legato Road, Suite 310, FAIRFAX, VA, 22033, US

(73) Assignee: Chien-Sheng FANG

(21) Appl. No.: 11/896,465

(22) Filed: Aug. 31, 2007

(51) Int. Cl. A01K 63/00

(52) U.S. Cl. 119/253; 119/265

(57) ABSTRACT

The present invention provides a covering structure for exterior of aquarium, which includes a peripheral covering layer configured with a plurality of slide grooves that provide effectiveness of tracks and enable a tight fit to the corners of an aquarium. The covering structure thus provides a sliding means to interplay with the aquarium, moreover, extending the peripheral covering layer provides additional holding space, and increasing the plurality of slide grooves enables further segmentation, thereby augmenting the holding capacity of the covering layer and enabling variability in outward appearance to transform the aquarium into a craftwork similar to a building. Furthermore, the covering structure is joined to the corners of the aquarium using the slide grooves and a mounting method, which saves on time and provides a quick method to change the outward appearance of the aquarium, presenting a design of economic benefit and improving appreciative value of the aquarium.

### BACKGROUND OF THE INVENTION

(a) Field of the Invention The art of the present invention provides a covering structure for exterior of aquarium, and more particularly to a peripheral covering layer provided with slide grooves designed with an inwardly recessed L-shape, which are used to join to the corners of an aquarium to enable a tight fit with the corners of the aquarium, and thereby avoid the danger of sliding off.

(b) Description of the Prior Art

Referring to FIG. 1 and FIG. 2, which show a conventional aquarium covering structure A, wherein the covering structure A is a bonded type structure that must be first disassembled if it is desired to replace the outward appearance, resulting in great inconvenience. Furthermore, if it is desired to set about decorating the scenery within an aquarium B, then the aquatic animals within the aquarium B must be rearranged. Moreover, an increase in ornaments within the aquarium B will certainly add to the cleaning time and degree of difficulty.

Hence, the inventor of the present invention proposes to resolve and surmount existent technical difficulties to eliminate the aforementioned shortcomings of prior art.

### SUMMARY OF THE INVENTION

The art of the present invention provides a covering structure for exterior of aquarium, and more particularly to a peripheral covering layer provided with slide grooves designed with an inwardly recessed L-shape, which are used to join to the corners of an aquarium to enable a tight fit with the corners of the aquarium, and thereby avoid the danger of sliding off. Moreover, the peripheral covering layer can be extended to provide different spaces and outward appearances, thereby enabling transformation into different craftwork styles, and when joined to an aquarium by a mounting means enables users to enjoy different visual and aesthetic effects.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a first elevational view of prior art.

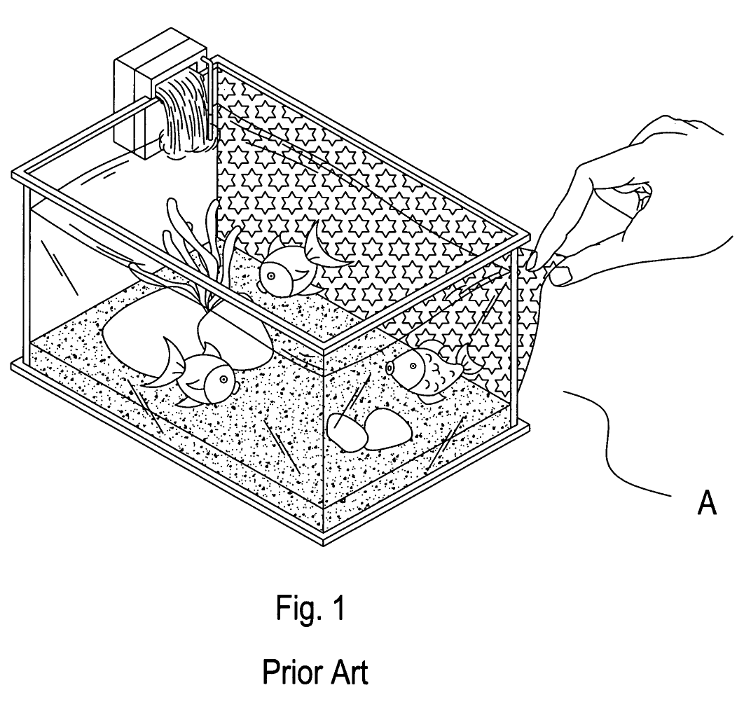

FIG. 2 shows a second elevational view of prior art.

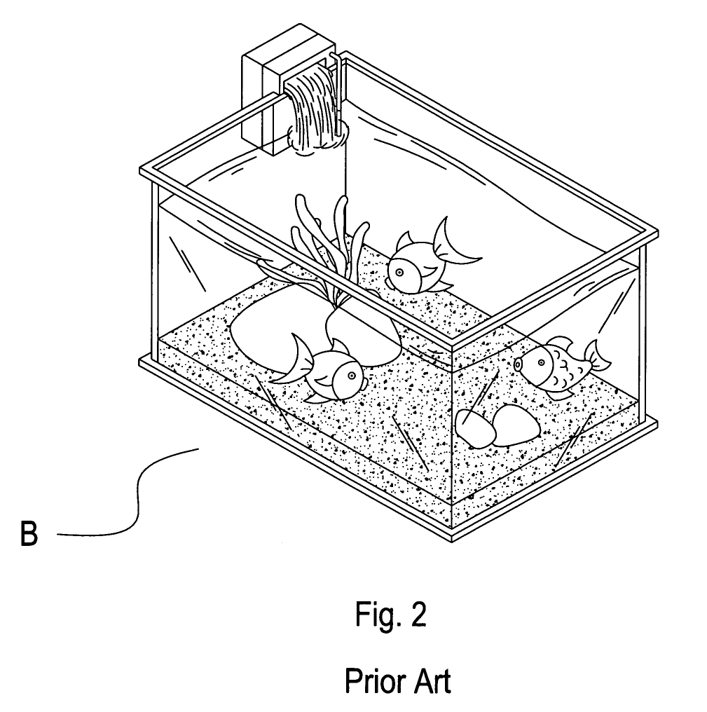

FIG. 3 shows an elevational view of the present invention.

FIG. 4 shows an exploded elevational view of the present invention.

FIG. 5 shows a first view of an embodiment according to the present invention.

FIG. 6 shows a first view of a further embodiment according to the present invention.

FIG. 7 shows a second view of a further embodiment according to the present invention.

FIG. 8 shows a third view of a further embodiment according to the present invention.

FIG. 9 shows a fourth view of a further embodiment according to the present invention.

FIG. 10 shows a fifth view of a further embodiment according to the present invention.

FIG. 11 shows a sixth view of a further embodiment according to the present invention.

### DETAILED DESCRIPTION OF THE PREFERRED EMBODIMENTS

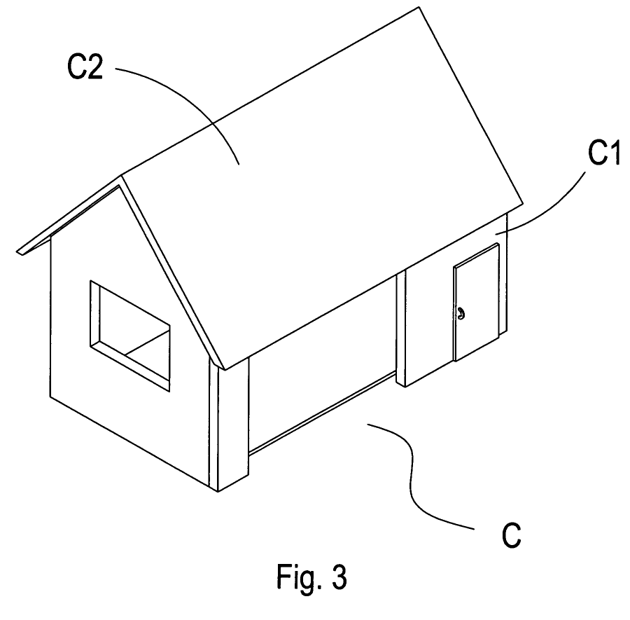

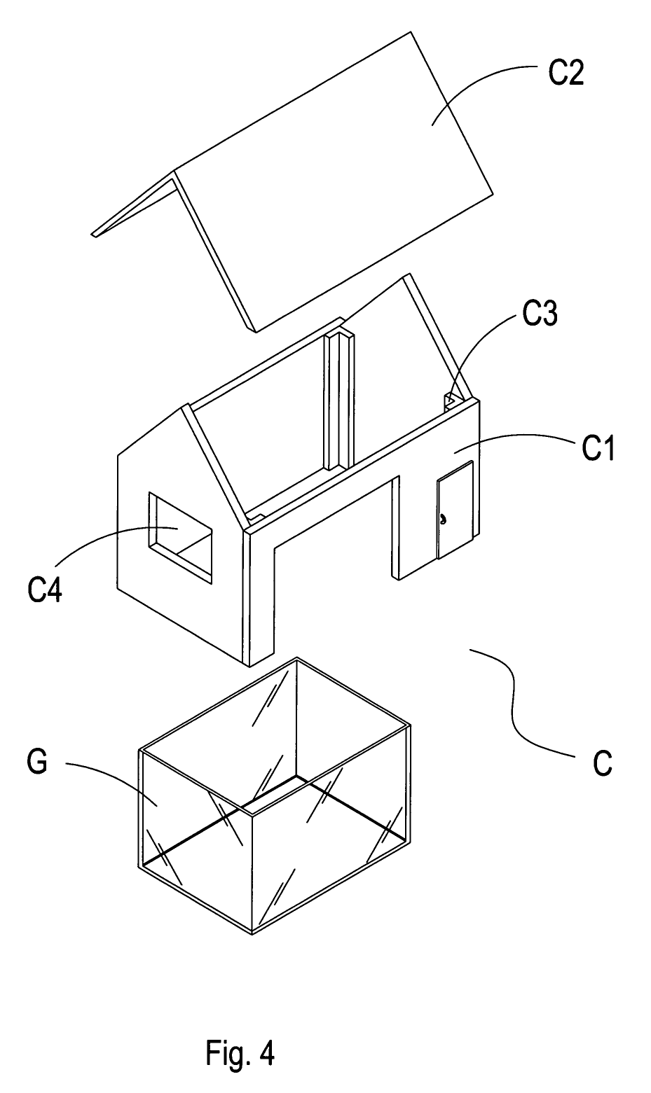

The present invention provides a covering structure for exterior of aquarium, as depicted in FIG. 3 and FIG. 4, in which a covering structure C comprises a peripheral covering layer C1 and an upper covering layer C2, wherein a plurality of slide grooves C3 are configured in the interior of the peripheral covering layer C1, and the slide grooves C3 are used to clamp the corners of an aquarium G. Moreover, a plurality of windows C4 are defined in the peripheral covering layer C1 to enable viewing and admiring the ecology within the aquarium G.

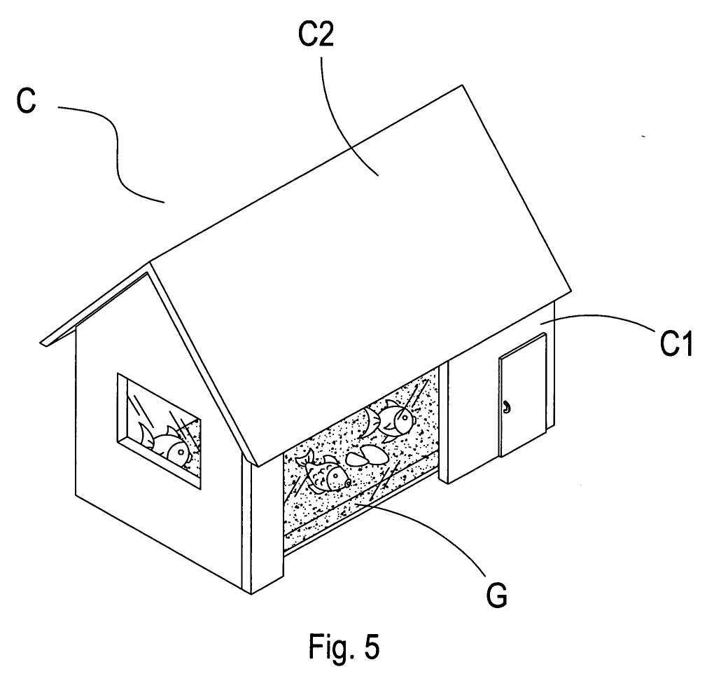

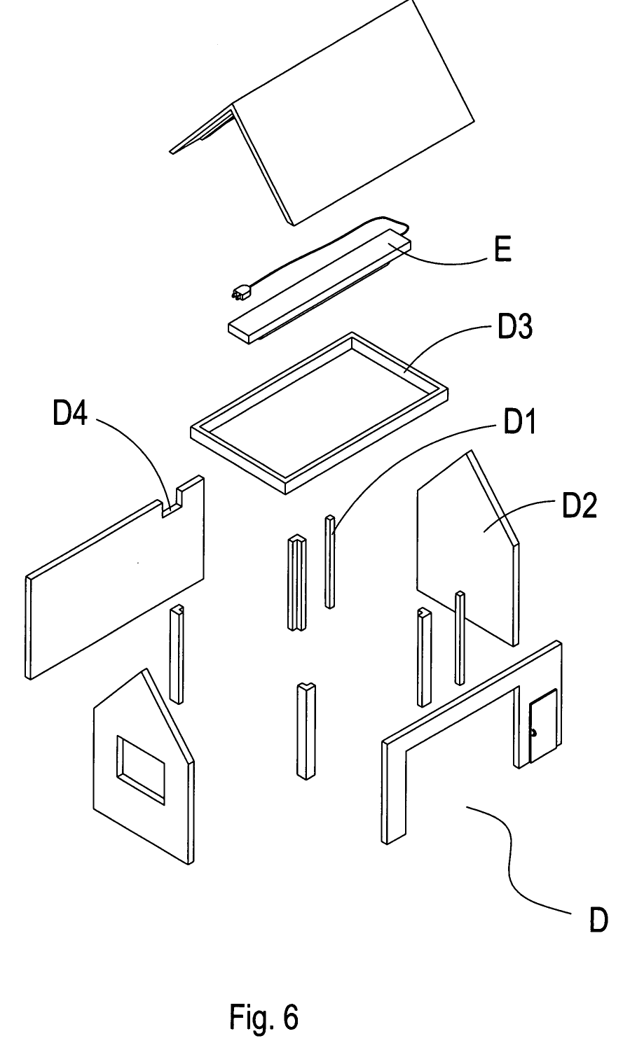

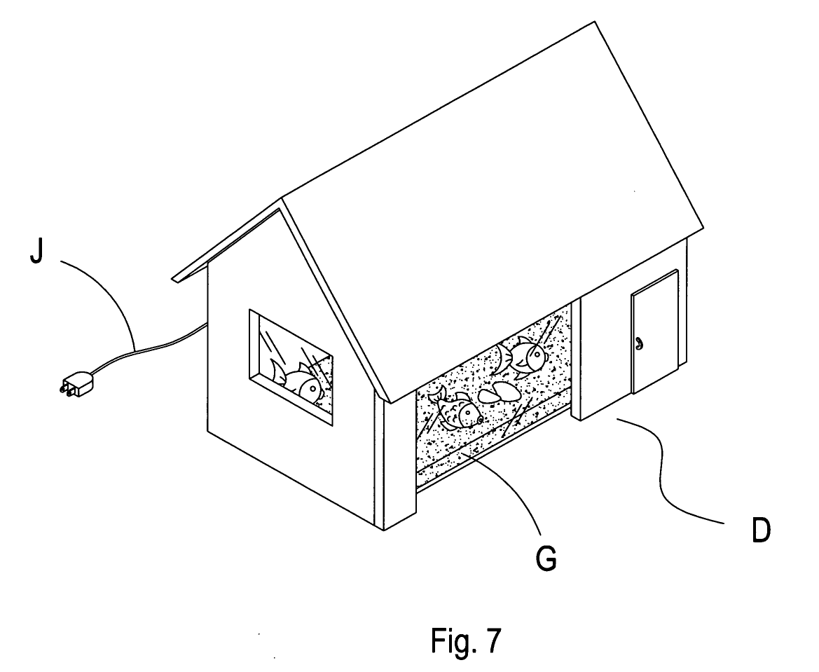

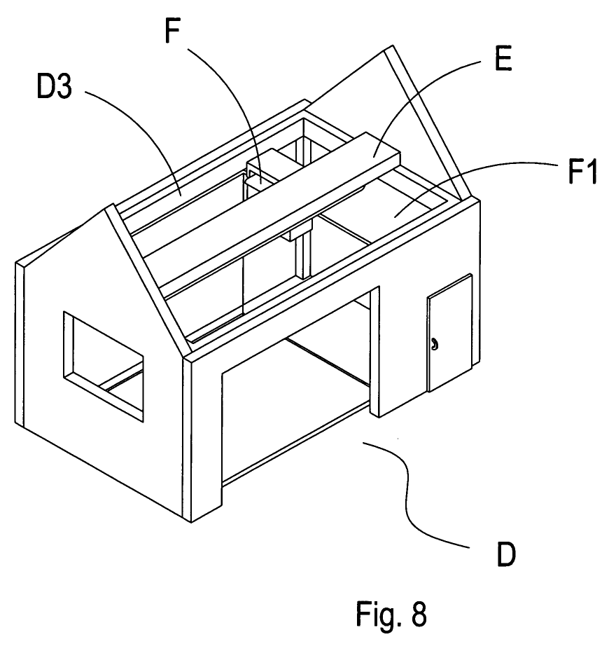

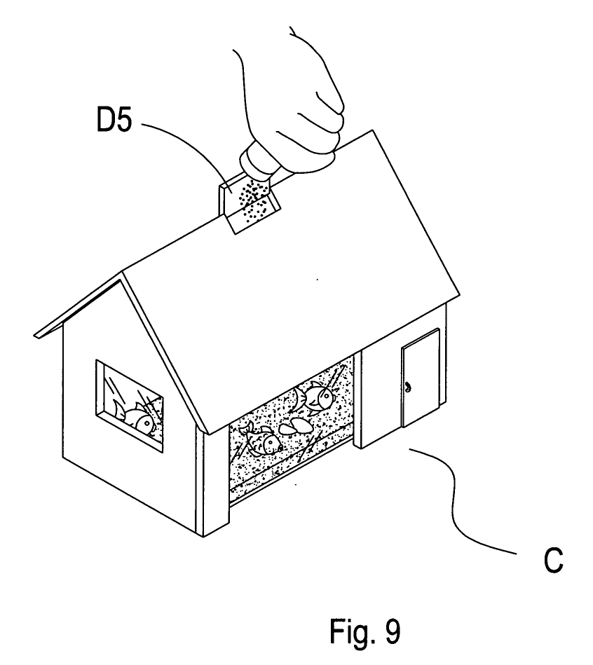

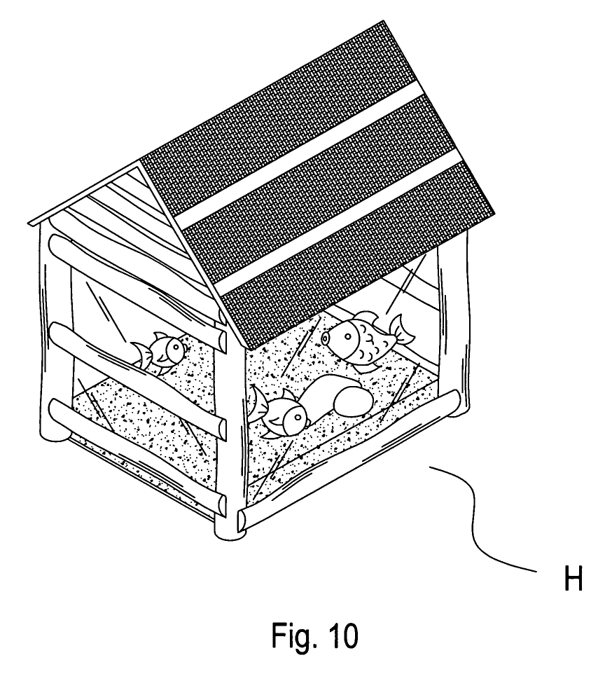

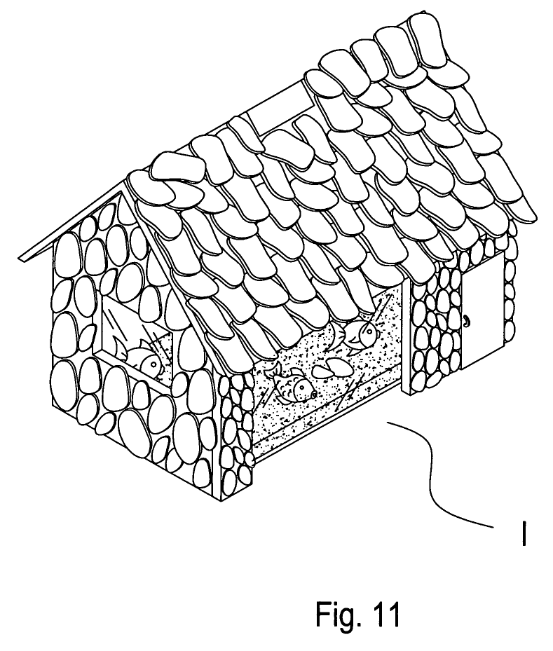

Referring to FIG. 4, FIG. 5, FIG. 6, FIG. 7, FIG. 8, FIG. 9, FIG. 10 and FIG. 11, which show embodiments of the covering structure for exterior of aquarium as provided by the present invention, wherein the covering structure C used to cover the aquarium G first utilizes the plurality of slide grooves C3 configured interior of the peripheral covering layer C1 to join to the corners of the aquarium G, in which the slide grooves C3 serve as tracks to enable mutual interplay between the L-shaped recessed slide grooves C3 of the peripheral covering layer C1 and the corners of the aquarium G, and thereby cause the peripheral covering layer C1 to completely cover the exterior of the aquarium G.

The covering structure C can be further configured as a combination type covering structure D, which is structured to comprise cylindrical bodies D1, panels D2 and a frame D3, wherein the cylindrical bodies D1 and the panels D2 are mutually clamped, and after completing assembly of the cylindrical bodies D1 and the panels D2 around the periphery of the aquarium G, then the frame D3 is disposed on the upper portion of the periphery of the already assembled covering structure D, and a lamp E is located on the frame D3. Once the lamp E and the frame D3 are covered, then assembly of the covering structure D is complete. Furthermore, after joining the cylindrical bodies D1 to the panels D2, then the frame D3, the lamp E and an upper cover can be located on top thereof, thus, after first competing assembly, then the entire covering structure D can be aligned with the corners of the aquarium G using slide grooves C3 defined interior of the cylindrical bodies D1 and downwardly fixedly mounted onto the exterior of the aquarium G. Moreover, viewing windows C4 defined in the covering structure D can be used to view the aquatic animals.

The lamp E can be additionally fitted to the frame D3 to provide illumination required by the aquatic animals within the aquarium G, and the covering structure D can be further extended using the cylindrical bodies D1. Furthermore, a periphery of the aquarium G is extended with a filter holding space F1, and the filter holding space F1 enables a filter F hooked onto a peripheral edge of the aquarium to be contained therein to preserve the aesthetic effect of the entire covering structure D.

An electric wire retaining hole D4 can be further defined in the panels D2 of the covering structure D, thereby providing a storage space for a power line J and facilitating keeping the power line J in good order. Moreover, an opening D5 can be further defined in an upper portion of the covering structure D to facilitate air circulation and feeding of aquatic animals within the aquarium.

The covering structure C can be further designed as a frame house covering structure H and a stone house covering structure I to achieve a visual effect similar to that of a building.

In order to better explicitly disclose advancement and practicability of the present invention, a comparison with prior art is described hereinafter:

### Shortcomings of Prior Art

1. Altering the external appearance of the bonded covering is inconvenient.

2. Rearrangement of the living space is necessary to alter the scenery within the aquarium and thus relatively troublesome.

3. Because of shortcoming 2, thus, degree of difficulty in replacing the water and cleaning is increased.

4. If decorations on the outer layer of the covering are insecure, then there is the danger of easily sliding off and shattering the fish tank when transporting.

### ADVANTAGES OF THE PRESENT INVENTION

1. Both mounting and taking off are convenient, which enables the covering structures providing different external appearances to be freely replaced.

2. No need to rearrange the living space and disposition of living specimens within an aquarium.

3. Recesses in the cylindrical bodies D1 are able to tightly clamp the corners of an aquarium, thereby ensuring safety when transporting.

4. The covering structures and the aquarium are independent ornamental entities, and do not affect ecology of the aquarium.

5. The peripheral covering layer C1 can prevent the aquatic animals from jumping out, and is able to camouflage non-ornamental apparatus, thereby maintaining overall aestheticism of the configuration.

6. The peripheral covering layer C1 adds a contrasting background effect to a rear end of an aquarium.

7. Provided with advancement and practicability.

8. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A covering structure for exterior of aquarium, comprising a peripheral covering layer and an upper covering layer, wherein the peripheral covering layer is configured with a plurality of slide grooves, and shape of the slide grooves enables fitting to the corners of an aquarium, moreover, the peripheral covering layer is configured with uncovered open spaces to enable viewing and admiring of the aquarium;
wherein shape of the plurality of slide grooves of the peripheral covering layer is changed according to the dimensions of different aquariums, an inwardly recessed L-shaped design of the slide grooves enables a tight fit to an aquarium, thereby enabling the peripheral covering layer to tightly mount onto the corners of the aquarium, and thus avoid the danger of the aquarium sliding off, moreover, the L-shaped slide grooves facilitate mutual interplay between the covering structure and the aquarium, and enable the covering structure to be quickly mounted onto and separated from the aquarium, thereby substantially saving on time and providing extreme convenience, moreover, the peripheral covering layer enables extending different exterior structures to achieve innovative amusement and improving appreciative value of the aquarium.

2. The covering structure for exterior of aquarium according to claim 1, wherein shape of the slide grooves configured in the peripheral covering layer is designed as an inwardly recessed circular arc shape, a triangular shape, and related shapes able to clamp to an aquarium.

3. The covering structure for exterior of aquarium according to claim 1, wherein material used is stone material, wood, plastic, cement, pottery clay, cardboard and related material able to increase the aesthetic outward appearance and is fabricable.

4. The covering structure for exterior of aquarium according to claim 1, wherein an assemblage of the covering structure further comprises an electric wire retaining hole defined in a rear end peripheral covering layer, which enables power lines for a filter, a lamp and a warming tube to be disposed therein, and facilitates keeping the power lines in order.

5. The covering structure for exterior of aquarium according to claim 1, wherein an assemblage of the covering structure further uses extending of the peripheral covering layer to increase space for holding a filter, the filter is disposed on a rear end of the rear end peripheral covering layer by a hook means, thereby maintaining an associative perception that increases visual enjoyment.

6. The covering structure for exterior of aquarium according to claim 1, wherein the covering structure is additionally configured with an opening to facilitate feeding aquatic animals within the aquarium and increase air circulation.
